(19) United States
(12) Patent Application Publication
(10) Pub. No.: US 2010/0190413 A1
(43) Pub. Date: Jul. 29, 2010

(54) POLISHING COMPOSITION

(76) Inventors: Kazuhiko NISHIMOTO, Wakayama-shi (JP); Kouji Taira, Wakayama-shi (JP); Kenichi Suenaga, Wakayama-shi (JP); Yuichi Honma, Wakayama-shi (JP)

Correspondence Address: BIRCH STEWART KOLASCH & BIRCH, PO BOX 747, FALLS CHURCH, VA, 22040-0747, US

(21) Appl. No.: 12/754,385

(22) Filed: Apr. 5, 2010

Related U.S. Application Data
(62) Division of application No. 11/184,960, filed on Jul. 20, 2005.

(30) Foreign Application Priority Data
Aug. 9, 2004 (JP) 2004-232378
Oct. 1, 2004 (JP) 2004-289475
Oct. 12, 2004 (JP) 2004-298117
Nov. 19, 2004 (JP) 2004-336601

(51) Int. Cl. B24B 1/00; C09K 3/14; C09G 1/02

(52) U.S. Cl. 451/28; 51/308

(57) ABSTRACT

A polishing composition containing an abrasive and water, wherein the polishing composition has a pH of from 0.1 to 7, and satisfies the following conditions: (1) that the number of polishing particles having sizes of 0.56 μm or more and less than 1 μm is 500,000 or less per 1 cm³ of the polishing composition; and (2) that the ratio of polishing particles having sizes of 1 μm or more is 0.001% by weight or less to the entire polishing particles in the polishing composition. The polishing composition is suitable for polishing substrates for precision parts including, for example, recording disk substrates, such as magnetic disks, optical disks, and opto-magnetic disks, photomask substrates, optical lenses, optical mirrors, optical prisms and semiconductor substrates, and the like.

This application is a Divisional of U.S. application Ser. No. 11/184,960, filed on Jul. 20, 2005, which claims priority to Japanese Application 2004-232378 filed on Aug. 9, 2004; Japanese Application 2004-289475 filed Oct. 1, 2004; Japanese Application 2004-298117 filed Oct. 12, 2004; and Japanese Application 2004-336601 filed Nov. 19, 2004. The entire contents of the above applications are hereby incorporated by reference.

### FIELD OF THE INVENTION

The present invention relates to a polishing composition and a polishing particle preparation which is used in the production of the polishing composition, and processes for producing these polishing composition and polishing particle preparation, and a method for manufacturing a substrate with the polishing composition.

### BACKGROUND OF THE INVENTION

In recent memory hard disk drives, high storage capacity and miniaturization have been demanded. In order to increase the recording density, it has been urged to lower the flying height of a magnetic head and to reduce the unit recording area. Along with this trend, even in a manufacturing step for a substrate for a magnetic disk, the surface qualities of the substrate required after polishing have become severely assessed every year. In other words, in order to satisfy the lowering of flying height of the magnetic head, the surface roughness, the microwaviness, the roll-off and projections are required to be reduced, and in order to satisfy the reduction in unit recording area, the acceptable number of scratches per one side of the substrate has been reduced, and the acceptable sizes and depths of the scratches have become increasingly smaller.

Also, in the field of semiconductors, highly integrated circuits and higher speed at the operating frequencies have been advanced, and the production of thinner wiring is required especially in highly integrated circuits. As a result, in the method for manufacturing a substrate for semiconductors, since the depth of focus becomes more shallow during the exposure of a photoresist, even more improvement in surface smoothness and planarization is desired.

In order to meet such requirements, in order to achieve the reduction of damages (scratches and the like) generated on the surface of the polished object for the purpose of improving the surface smoothness, JP2000-15560 A, JP2001-271058 A, JP2003-188122 A, or JP2003-155471 A discloses a polishing liquid slurry having the reduced number of coarse particles; and JP2002-97387 A or JP-A-Hei-11-57454 discloses a process for producing a polishing liquid slurry having the reduced number of coarse particles. Further, in order to achieve reduction in microwaviness and reduction in micropits of the surface of a polished object for the purpose of improving surface smoothness, JP2004-204151 A, JP2004-259421 A, or JP2004-204155 A discloses a polishing composition which defines a particle size distribution of the polishing particles.

However, there has yet been desired to develop a polishing composition which can meet the requirement of an even higher densification such as high storage capacity and high integration.

### SUMMARY OF THE INVENTION

Specifically, the present invention relates to:

[1] a polishing composition containing an abrasive and water, wherein the polishing composition has a pH of from 0.1 to 7, and satisfies the following conditions:
(1) that the number of polishing particles having sizes of 0.56 μm or more and less than 1 μm is 500,000 or less per 1 cm³ of the polishing composition; and
(2) that the ratio of polishing particles having sizes of 1 μm or more is 0.001% by weight or less to the entire polishing particles in the polishing composition;
[2] a polishing particle preparation containing an abrasive and water, satisfying the following conditions:
(i) that the number of polishing particles having sizes of 0.56 μm or more and less than 1 μm is 500,000 or less per 1 cm³ of the polishing particle preparation; and
(ii) that the ratio of polishing particles having sizes of 1 μm or more is 0.001% by weight or less to the entire polishing particles in the polishing particle preparation, wherein the polishing particle preparation is used in the preparation of the polishing composition as defined in the above item [1];
[3] a process for producing the polishing composition as defined in the above item [1], including the following purification steps of:
(I) filtering a pre-purification polishing composition with a depth-type filter, to give an intermediate filtrate; and
(II) filtering the intermediate filtrate with a pleated type filter, to give the polishing composition,
wherein the fluctuation range of the pressure at an inlet of the depth-type filter in the step (I) is 50 kPa or less;
[4] a process for producing the polishing particle preparation as defined in the above item [2], including the following purification steps of:
(I′) filtering a pre-purification polishing particle preparation with a depth-type filter, to give an intermediate filtrate; and
(II′) filtering the intermediate filtrate with a pleated type filter, to give the polishing particle preparation,
wherein the fluctuation range of the pressure at an inlet of the depth-type filter in the step (I′) is 50 kPa or less; and
[5] a method for manufacturing a substrate, including the step of polishing a substrate with a polishing machine using the polishing composition as defined in the above item [1].

### DETAILED DESCRIPTION OF THE INVENTION

The embodiment 1 of the present invention relates to a polishing composition being capable of giving a polished object with a small surface roughness, of remarkably reducing nano scratches which are important factors in high densification, and of economically polishing the object to be polished; a polishing particle preparation which is used for producing the polishing composition; and a method for manufacturing a substrate including the step of polishing a substrate using the polishing composition.

The embodiment 2 of the present invention relates to a process capable of economically producing the polishing composition and the polishing particle preparation which is used for producing the polishing composition.

The embodiment 3 of the present invention relates to a method for manufacturing a substrate including a polishing step, which is capable of remarkably reducing the above-mentioned nano scratches, which is an important in high densification and also economically polishing the substrate in the polishing step of a precision part substrate such as a memory hard disk or semiconductor element.

There are exhibited some excellent effects that the polishing composition of the present invention realizes an economical polishing rate, gives the polished substrate excellent surface smoothness, and is capable of remarkably reducing fine nano scratches by being used, for example, in the polishing step of a substrate for precision parts for high density or high integration. Therefore, a high-quality substrate for precision parts, such as a magnetic disk substrate or a substrate for semiconductor element, which has excellent surface properties, can be manufactured.

In addition, by using the processes of the present invention, there are exhibited some effects that the polishing composition, or a polishing particle preparation which is used for producing the polishing composition can be prepared without impairing its productivity.

Further, according to the method for manufacturing a substrate of the present invention, since a remarkable reduction in nano scratches of the polished substrate can be realized, there are exhibited some effects that a high-quality substrate for precision parts, such as a memory hard disk substrate or a substrate for semiconductor element, which has excellent surface properties, can be economically manufactured.

These and other advantages of the present invention will be apparent from the following description.

### Embodiment 1 of the Present Invention

A feature of the polishing composition of the present invention resides in that the polishing composition contains an abrasive and water, wherein the polishing composition has a pH of from 0.1 to 7, and satisfies the following conditions:

(1) that the number of polishing particles having sizes of 0.56 μm or more and less than 1 μm is 500,000 or less per 1 cm³ of the polishing composition; and
(2) that the ratio of polishing particles having sizes of 1 μm or more is 0.001% by weight or less to the entire polishing particles in the polishing composition. Since the polishing composition has the above feature, nano scratches which could cause defects can be remarkably reduced, whereby a substrate having excellent surface properties can be provided at an economical polishing rate. The nano scratches are an important property especially for increasing the recording density of the memory hard disk substrate or the integration of the semiconductor substrate. Therefore, a high-quality memory hard disk substrate or a substrate for semiconductor element having excellent surface properties can be manufactured by using the polishing composition of the present invention.

The term “nano scratches” as used herein refers to fine scratches on a substrate surface having a depth of 10 nm or more and less than 100 nm, a width of 5 nm or more and less than 500 nm, and a length of 100 μm or more. The nano scratches can be detected with an atomic force microscope (AFM), and can be quantitatively evaluated as the number of nano scratches by determination with “MicroMax” commercially available from VISION PSYTEC a visual inspecting device as described in Examples set forth below.

The above-mentioned nano scratches are fine surface defects which have not been conventionally detected. In other words, when a conventionally known method is used, the quality of the substrate for high densification such as an even higher recording capacity or higher integration has not been satisfactory. The present inventors have intensively studied the causations therefor. As a result, they have found for the first time that the reduction in the “nano scratches” which have not been so far detected are unsatisfactory.

The mechanism for reducing the nano scratches is not elucidated. Although not wanting to be limited by theory, it is presumed that aggregates of polishing primary particles or coarse polishing primary particles contained in the polishing composition are contacted with the surface of an object to be polished by undergoing a local load under a polishing pressure, whereby the deep nano scratches are generated. There have been elucidated that the number of particles having sizes in the order of submicron influences the nano scratches because scratches are generated by a single particle or an aggregate of those particles, and that the weight of the particles having sizes in the order of micron influences the nano scratches because the larger the particles, the more likely the occurrences of scratches. The term “polishing particle(s)” in the polishing composition includes not only primary particles used herein but also an aggregated particle in which the primary particles are aggregated.

In the present invention, the preferred range for the reduced number of nano scratches of the polished substrate is 1.5 or less per 1 cm² according to the nano scratch standard test, more preferably 1.2 or less, even more preferably 0.9 or less, and even more preferably 0.6 or less, from the viewpoint of manufacturing a high-precision substrate.

Here, the procedures for the nano scratch standard test are as follows.

### Nano Scratch Standard Test

1. Substrate to be polished: A Ni-P-plated aluminum alloy substrate (previously roughly polished with a polishing composition containing an alumina abrasive, to adjust the average surface roughness (AFM-Ra) to 10 A (1 nm)) having a thickness of 1.27 mm, an outer diameter of 95 mm and an inner diameter of 25 mm.

### 2. Polishing Conditions

Polishing testing machine: double-sided 9B polishing machine, commercially available from Speedfam Co., Ltd.
Polishing pad: a finishing polishing pad made of urethane, commercially available from FUJIBO (FUJI SPINNING Co., Ltd.) (thickness: 0.9 mm, average pore size: 30 μm)
Rotational speed of an upper platen: 32.5 r/min
Feed amount (flow rate) for a polishing composition: 100 mL/min
Concentration of an abrasive of a polishing composition: 7% by weight
Polishing time period: 4 minutes
Polishing pressure: 7.8 kPa
Number of substrates introduced: 10

### 3. Determination Conditions for Nano Scratches

Measurement equipment: “MicroMax VMX-2100CSP” commercially available from VISION PSYTEC CO., LTD.
Light source: 2Sλ (250W) and 3Pλ (250W) being both 100%
Tilt angle: −6°
Magnification: maximum (scope of vision: 1/120 of the entire area)
Observed range: entire area (a substrate having an outer diameter of 95 mm and an inner diameter of 25 mm)
Iris: notch
Evaluation: Four pieces of substrates are randomly selected from 10 substrates introduced into the polishing machine, and a total of the number of nano scratches on each of both sides of the four substrates is divided by 8 to calculate the number of nano scratches per side of the substrate. The resulting value is divided by an area (65.97 cm²) of an object to be polished of one side to calculate and evaluate the number of nano scratches per 1 cm² of the substrate.

The number of polishing particles having sizes of 0.56 μm or more and less than 1 μm is 500,000 or less per 1 cm³ of the polishing composition, and preferably 400,000 or less, more preferably 300,000 or less, even more preferably 200,000 or less, and even more preferably 100,000 or less, from the viewpoint of reducing nano scratches. Here, the phrase “having sizes of 0.56 μm or more and less than 1 μm” refers to particle sizes of the polishing particles.

In addition, the ratio of polishing particles having sizes of 1 μm or more is 0.001% by weight or less to the entire polishing particles in the polishing composition, and the ratio is preferably 0.0008% by weight or less, more preferably 0.0007% by weight or less, even more preferably 0.0006% by weight or less, and even more preferably 0.0005% by weight or less, from the viewpoint of reducing nano scratches.

In addition, the ratio of polishing particles having sizes of 3 μm or more is, for example, 0.0008% by weight or less to the entire polishing particles in the polishing composition, and preferably 0.0007% by weight or less, more preferably 0.0006% by weight or less, even more preferably 0.0005% by weight or less, and even more preferably 0.0004% by weight or less, from the viewpoint of reducing nano scratches.

As to the particle size of the polishing particles in the polishing composition, Sizing Particle Optical Sensing method can be employed, and the particle size can be determined by “Accusizer 780” commercially available from Particle Sizing Systems, “Coulter Counter” commercially available from Coulter, and the like.

A method of controlling the number of polishing particles having sizes of 0.56 μm or more and less than 1 or a content of polishing particles having sizes of 1 μm or more, or having sizes of 3 μm or more is not limited. A method of general dispersion or particle removal can be employed during or after the production of the polishing composition. For example, a dispersion method using a high-speed dispersion device or a high-pressure dispersion device such as a high-pressure homogenizer; a precipitation method by a centrifuge or the like; and a filtration method such as a precision filtration or ultrafiltration with a filter material can be utilized. Each of these methods can be used for the treatment alone or in combination of two or more kinds, and the order of treatments of the combination is not limited in any manner. In addition, the treatment conditions and the number of treatments can be appropriately selected and used.

Among them, as the method for effectively and economically removing aggregates of the polishing primary particles and coarse polishing primary particles contained in the polishing composition, a precision filtration with a filter is suitably used.

As the filter material used for a precision filtration, a depth-type filter or a pleated type filter can be used. As the depth-type filter, a bag style filter (one commercially available from Sumitomo 3M Limited or the like), as well as a cathidge style filter (one commercially available from Advantec Toyo Kaisha, Ltd., Nihon Pall Ltd., CUNO Incorporated, Daiwabo Co., Ltd. or the like) can be used.

The features of the depth-type filter are that the filter material has a pore structure that is rough at an inlet side and fine at an outlet side, and that the pore structure of the filter material becomes finer continuously or stepwise from the inlet side towards the outlet side. Specifically, larger particles among the coarse particles are captured near the inlet side, and smaller particles among the coarse particles are captured near the outlet side. In addition, the coarser the particles, the higher the likelihood of removability of the particles because the particles are captured in the direction of a thickness of the filter in multiple steps. The shape of the depth-type filter may be a bag style in the form of a sac, or a cartridge style in the form of a hollow cylinder. In addition, since a filter obtained by simply molding those filter materials having the above-mentioned features to the pleated form also has the function of the depth-type filter, the filter is classified as depth-type filters.

The pleated type filter refers to one produced by forming a filter material in the pleated form, to give a hollow cylindrical cartridge style filter. Contrary to the depth-type filter in which the particles are captured in each portion in the direction of the thickness of the filter, the feature of the pleated type filter resides in that the filter has a small thickness of the filter material, so that it is said that the particles are mainly captured on the surface of the filter, whereby generally giving a high filtration precision.

The filtration method may be a recirculation method in which filtration is repeatedly carried out, or a one-pass method. Alternatively, a batch process in which a one-pass method is repeated may be used. As to the method of passing the liquid, a pump is preferably used in the recirculation method, and a pressure filtration method in which an air pressure or the like is introduced into a tank can be used in addition to the use of the pump in the one-pass method.

The particle size of the coarse particles to be removed can be controlled by properly selecting the pore structure of the filter.

The filter system may be a single-step filtration, or a multiple-step filtration in a combination thereof. The multi-step filtration has advantages of improving the particle size control (filtration precision) of the coarse particles to be removed and an economic advantage by properly selecting a pore size of the filter and a structure of the filter material, and further properly selecting the order of the processing of the filter. In other words, when a filter having a large pore structure is used as the earlier step, and a filter having a fine pore structure as the subsequent step, there is an advantage that the life of the filter can be extended overall. In the structure of the filter material, when the depth-type filter is used as the earlier step and the pleated type filter is used as the subsequent step, there is an advantage that the life of the filter can be extended overall.

As the abrasive usable in the present invention, the abrasives that are generally used for polishing can be used. The abrasive includes metals; carbides of metals or metalloids, nitrides of metals or metalloids, oxides of metals or metalloids or borides of metals or metalloids; diamond, and the like. The elements for metals or metalloids include those elements belonging to the Group 2A, 2B, 3A, 3B, 4A, 4B, 5A, 6A, 7A or 8 of the Periodic Table (long period form). Specific examples of the abrasives include silicon oxide (hereinafter also referred to as silica), aluminum oxide (hereinafter also referred to as alumina), silicon carbide, diamond, manganese oxide, magnesium oxide, zinc oxide, titanium oxide (hereinafter also referred to as titania), cerium oxide (hereinafter also referred to as ceria), zirconium oxide, and the like. It is preferable to use one or more kinds of these abrasives from the viewpoint of an increase in the polishing rate. Among them, silica, alumina, titania, ceria, zirconium oxide, and the like are suitable for polishing a substrate for precision parts such as a substrate for a semiconductor element, or a substrate for a magnetic disk.

The polishing particles are preferably colloidal particles and fumed particles, from the viewpoint of reduction of nano scratches which are surface defects. Among the polishing particles, the colloidal particles are preferable, and the colloidal particles include, for example, colloidal silica particles, colloidal ceria particles, colloidal alumina particles, and colloidal titania particles, and the colloidal silica particles are more preferable. The colloidal silica particles can be prepared by a process of generating silica particles from, for example, an aqueous silicic acid solution. In addition, one obtained by surface-modifying or surface-improving these polishing particles with a functional group, one obtained by forming composite particles with a surfactant or other abrasive or the like can be used.

The abrasive has an average particle size of the primary particles of preferably from 1 to 50 nm, from the viewpoint of reducing the nano scratches and lowering the surface roughness (average surface roughness: Ra, peak-to-valley value: Rmax). The abrasive has an average particle size of the primary particles of more preferably from 3 to 50 nm, even more preferably from 5 to 40 nm, and even more preferably from 5 to 30 nm, from the viewpoint of simultaneously increasing the polishing rate.

The average particle size of the primary particles of the abrasive can be obtained as an average particle size according to a method of obtaining a particle size from an observed image through a transmission electron microscope (TEM), titration method, or BET method.

The content of the abrasive is preferably 0.5% by weight or more, more preferably 1% by weight or more, even more preferably 3% by weight or more, and even more preferably 5% by weight or more, of the polishing composition upon use from the viewpoint of increasing the polishing rate. In addition, the content of the abrasive is preferably 20% by weight or less, more preferably 15% by weight or less, even more preferably 13% by weight or less, and even more preferably 10% by weight or less, of the polishing composition upon use, from the viewpoint of economically improving surface quality. Therefore, the content of the abrasive is preferably from 0.5 to 20% by weight, more preferably from 1 to 15% by weight, even more preferably from 3 to 13% by weight, and even more preferably from 5 to 10% by weight, of the polishing composition, from the viewpoint of increasing the polishing rate and economically improving surface quality. The content of the abrasive may be any content during the production of the polishing composition and the content upon use. In many cases, the polishing composition is usually prepared as a concentrate, which is diluted upon use.

Water usable in the present invention includes ion exchanged water, distilled water, ultrapure water and the like. The content of water which corresponds to the balance excluding the abrasive and the other components from 100% by weight, is preferably from 60 to 99% by weight, and more preferably from 80 to 97% by weight, of the polishing composition.

The polishing composition of the present invention has a pH of from 0.1 to 7. Under alkaline conditions, the occurrences of nano scratches are remarkable as compared to those under acidic conditions. Although not wanting to be limited by theory, although the mechanism for occurrences of nano scratches is not elucidated, it is presumably as follows. Under alkaline atmosphere in which the polishing particles themselves are strongly repulsive to each other by surface charges, the aggregates of the polishing primary particles or coarse polishing primary particles contained in the polishing composition are not densely packed in the polishing portion, whereby under polishing pressure a local load is more likely to be generated thereto. The pH is preferably determined according to the kinds of the objects to be polished and their required properties. When the material of the object to be polished is a metallic material, the pH is preferably 6 or less, more preferably 5 or less, and even more preferably 4 or less, from the viewpoint of increasing the polishing rate. In addition, the pH is preferably 0.5 or more, more preferably 1 or more, and even more preferably 1.4 or more, from the viewpoint of the influence to human bodies and corrosion resistance of the polishing machine. Especially, in the substrate for precision parts in which the material of the object to be polished is a metallic material as in the case of a nickel-phosphorus (Ni-P) plated aluminum alloy substrate, the pH is preferably from 0.5 to 6, more preferably from 1.0 to 5, and even preferably from 1.4 to 4, from the above-mentioned viewpoint.

The pH can be adjusted with the following acid or a salt thereof. Specific examples of the acid or a salt thereof include inorganic acids such as nitric acid, sulfuric acid, nitrous acid, persulfuric acid, hydrochloric acid, perchloric acid, phosphoric acid, phosphonic acid, phosphinic acid, pyrophosphoric acid, tripolyphosphoric acid, and amide sulfuric acid, or salts thereof; organic phosphonic acids such as 2-aminoethylphosphonic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acids, methanehydroxyphosphonic acid, 2-phosphonobutane-1,2-dicarboxylic acids, 1-phosphonobutane-2,3,4-tricarboxylic acids, and α-methylphosphonosuccinic acid, or salts thereof; aminocarboxylic acids such as glutamic acid, picolinic acid, and aspartic acid, or salts thereof; carboxylic acids, such as oxalic acid, nitroacetic acid, maleic acid and oxaloacetic acid, or salts thereof; and the like. Among them, the inorganic acids, the organic phosphonic acids and salts thereof are preferable from the viewpoint of reduction of nano scratches.

In addition, among the inorganic acids or salts thereof, nitric acid, sulfuric acid, hydrochloric acid, perchloric acid, or a salt thereof is more preferable. Among the organic phosphonic acids or salts thereof, 1-hydroxyethylidene-1,1-diphosphonic acid, aminotri(methylenephosphonic acid), ethylenediaminetetra(methylenephosphonic acid), diethylenetriaminepenta(methylenephosphonic acid), or a salt thereof is more preferable. These acids or salts thereof may be used alone or in admixture of two or more kinds.

The counterion (cation) of these salts is not particularly limited. Specific examples of the counterion of these salts include a metal ion, ammonium ion, or an alkylammonium ion. Specific examples of the metal include the metals belonging to the Group 1A, 1B, 2A, 2B, 3A, 3B, 4A, 6A, 7A or 8 of the Periodic Table (long period form). The ammonium ion or the metal belonging to the Group 1A of the periodic table is preferable, from the viewpoint of reduction of nano scratches.

In addition, there can be added other component to the polishing composition of the present invention as occasion demands. The other component includes, for example, thickeners, dispersing agents, anticorrosive agents, basic substances, surfactants, and the like. In addition, although it cannot be generally defined depending upon the materials of the object to be polished, in general, an oxidizing agent can be added for the metal material, from the viewpoint of increasing the polishing rate. The oxidizing agent includes hydrogen peroxide, permanganic acid, chromic acid, nitric acid, peroxo acid, oxyacid, or salts thereof, and oxidizable metal salts.

The polishing composition of the present invention having the constitution as mentioned above can be prepared by mixing each of the above-mentioned components with a known method.

The process for producing a polishing composition includes, for example, the following two manners.

(1) a method including the step of adding other components to a mixture prepared by mixing a polishing particle preparation and water; and
(2) a method including the step of adding a polishing particle preparation to a mixture of other components and water.

Among them, it is preferable from the viewpoint of economic advantages that the polishing composition of the present invention is first produced by preparing a polishing particle preparation (Embodiment A-1) containing an abrasive and water, satisfying the following conditions:

(i) that the number of polishing particles having sizes of 0.56 μm or more and less than 1 μm is 500,000 or less per 1 cm³ of the polishing particle preparation; and
(ii) that the ratio of polishing particles having sizes of 1 μm or more is 0.001% by weight or less to the entire polishing particles in the polishing particle preparation as a concentrate, and thereafter formulating other components as mentioned above to the polishing particle preparation.

In addition, the process (2) in which the polishing particle preparation (Embodiment A-1) is added to a mixture of other components and water is preferable, from the viewpoint of dispersion stability of the abrasive.

Here, in the process (1), other components can be used by diluting with a proper amount of water as occasion demands.

Therefore, the present invention also relates to a polishing particle preparation.

The polishing particle preparation may be those used in the process (1) or (2) mentioned above for producing the polishing composition, and includes, besides the above-mentioned Embodiment A-1, the following embodiments:

(Embodiment A-2) a polishing particle preparation according to Embodiment A-1, further satisfying the following conditions:
(iii) that the ratio of polishing particles having sizes of 3 μm or more is 0.0008% by weight or less to the entire polishing particles in the polishing particle preparation;
(Embodiment A-3) a polishing particle preparation according to Embodiment A-1 or A-2, wherein the abrasive has an average particle size of primary particles of from 1 to 50 nm;
(Embodiment A-4) a polishing particle preparation according to any one of Embodiment A-1 to A-3, wherein the abrasive is contained in the polishing particle preparation in an amount of from 1 to 60% by weight;
(Embodiment A-5) a polishing particle preparation according to any one of Embodiment A-1 to A-4, wherein the abrasive is colloidal silica;
(Embodiment A-6) a polishing particle preparation according to any one of Embodiments A-1 to A-5, wherein the polishing particle preparation is used for producing the polishing composition used for a magnetic disk substrate; and
(Embodiment A-7) a polishing particle preparation according to any one of Embodiments A-1 to A-6, wherein the polishing particle preparation is used for producing the polishing composition, wherein the number of nano scratches of a polished substrate is 1.5 or less per 1 cm² according to a standard test.

The content of the abrasive in the polishing particle preparation is preferably 1% by weight or more, more preferably 5% by weight or more, and even more preferably 10% by weight or more, from the viewpoint of increasing the polishing rate, and the content is preferably 60% by weight or less, and more preferably 50% by weight or less, from the viewpoint of economically improving the surface quality. Therefore, the content is preferably from 1 to 60% by weight, more preferably from 5 to 50% by weight, and even more preferably from 10 to 50% by weight.

In addition, the content of water in the polishing particle preparation is preferably 40% by weight or more, and more preferably 50% by weight or more, from the viewpoint of fluidity of the polishing particle preparation, and the content is preferably 99% by weight or less, more preferably 95% by weight or less, and even more preferably 90% by weight or less, from the viewpoint of increasing the polishing rate. Therefore, the content is preferably from 40 to 99% by weight, more preferably from 50 to 95% by weight, and even more preferably from 50 to 90% by weight.

The above-mentioned polishing particle preparation can be suitably used in the preparation of the polishing compositions of the following Embodiments 1 to 7: (Embodiment 1) a polishing composition containing an abrasive and water, wherein the polishing composition has a pH of from 0.1 to 7, and satisfies the following conditions:

(1) that the number of polishing particles having sizes of 0.56 μm or more and less than 1 μm is 500,000 or less per 1 cm³ of the polishing composition; and
(2) that the ratio of polishing particles having sizes of 1 μm or more is 0.001% by weight or less to the entire polishing particles in the polishing composition;
(Embodiment 2) the polishing composition according to Embodiment 1, wherein the polishing composition further satisfies the following condition:
(3) that the ratio of polishing particles having sizes of 3 μm or more is 0.0008% by weight or less to the entire polishing particles in the polishing composition;
(Embodiment 3) the polishing composition according to Embodiment 1 or 2, wherein the abrasive has an average particle size of primary particles of from 1 to 50 nm.
(Embodiment 4) the polishing composition according to any one of Embodiments 1 to 3, wherein the abrasive is contained in the polishing composition in an amount of from 0.5 to 20% by weight;
(Embodiment 5) the polishing composition according to any one of Embodiments 1 to 4, wherein the abrasive is colloidal silica;
(Embodiment 6) the polishing composition according to any one of Embodiments 1 to 5, wherein the polishing composition is used for a magnetic disk substrate; and
(Embodiment 7) the polishing composition according to any one of Embodiments 1 to 6, wherein the number of nano scratches of a polished substrate is 1.5 or less per 1 cm² according to a standard test.

The polishing composition of the present invention can be used while contacting the substrate in the polishing step which includes the step of feeding the polishing composition between a polishing pad, such as a nonwoven organic polymer-based polishing pad and a substrate to be polished, i.e. feeding the polishing composition to the polishing side of the substrate placed between polishing platens to which the polishing pad is attached, and moving the polishing platens and/or the substrate, while applying a given load. The generation of the nano scratches can be remarkably suppressed by this polishing step.

In order to effectively reduce the nano scratches, the substrate to be polished is polished with the polishing composition of the present invention, or while a polishing composition being prepared by mixing each of the components so as to have the polishing composition of the present invention. By polishing the substrate to be polished as mentioned above, a substrate having excellent surface quality can be manufactured, the surface defects of the substrate, particularly nano scratches, being remarkably reduced, even more lower surface roughness being lowered. Therefore, the present invention also relates to a method for manufacturing a substrate, including the step of polishing a substrate with a polishing machine using the polishing composition of the present invention.

The polishing composition of the present invention can be preferably used in the manufacture a substrate for precision parts. For example, the polishing composition is suitable for polishing substrates for precision parts, including recording disk substrates such as magnetic disks, opto-magnetic disks and optical disks; and photomask substrates, optical lenses, optical mirrors, optical prisms, and semiconductor substrates, and the like. In the manufacture of the semiconductor substrate, the polishing composition of the present invention can be used in the steps of polishing a silicon wafer (bare wafer), forming an embedded metal line, subjecting an interlayer dielectric to planarization, forming a film for shallow trench isolation, and forming an embedded capacitor, and the like.

The polishing composition of the present invention is especially effective in the polishing step, and the polishing composition can be similarly applied to grinding steps other than this, for example, lapping step, and the like.

The material of a substrate to be polished, which is suitably used for the polishing composition of the present invention, includes, for example, metals or metalloids such as silicon, aluminum, nickel, tungsten, copper, tantalum and titanium, and alloys thereof; glassy substances such as glass, glassy carbon and amorphous carbons; ceramic materials such as alumina, silicon dioxide, silicon nitride, tantalum nitride, and titanium carbide; resins such as polyimide resins; and the like. Among them, a substrate to be polished is preferably made of a metal such as aluminum, nickel, tungsten or copper, or made of an alloy containing these metals as the main components. For example, a Ni-P plated aluminum alloy substrate and a glass substrate made of crystallized glass, reinforced glass or the like are more preferable, and a Ni-P plated aluminum alloy substrate is even more preferable.

The shape of the substrate to be polished is not particularly limited. For example, those having shapes containing planar portions such as discs, plates, slabs and prisms, or shapes containing curved portions such as lenses can be subjects for polishing with the polishing composition of the present invention. Among them, disc-shaped substrates to be polished are even more preferable for the polishing.

In addition, the evaluation method for surface roughness, which is a measure of surface smoothness, is not limited. In the present invention, the surface roughness is evaluated as roughness that can be determined at a short wavelength of 10 μm or less in the AFM (atomic force microscope), and expressed as an average surface roughness (AFM-Ra). Specifically, the polishing composition of the present invention is suitable for a polishing step for a magnetic disk substrate, further for a polishing step for reducing the surface roughness (AFM-Ra) of the polished surface to 2.0 Å (0.20 nm) or less.

When the manufacturing steps for a substrate includes plural polishing steps, the polishing composition of the present invention is preferably used in the second or subsequent step among the multi-polishing steps, and it is more preferable that the polishing composition of the present invention is used in the polishing step as a finish-polishing step, from the viewpoint of remarkably reducing nano scratches and surface roughness, thereby obtaining excellent surface smoothness. The finish-polishing step refers to at least one of final polishing steps in a case there are multi-polishing steps.

In this polishing step, in order to avoid admixing of the abrasive or the polishing composition of the earlier step, separate polishing machines may be used for the individual polishing step. And when the separate polishing machines are used, it is preferable to clean the substrate for each step. Here, the polishing machines are not particularly limited. The substrate manufactured as described above has a remarkable reduction in the nano scratches, and excellent surface smoothness. In other words, the surface roughness (AFM-Ra) of the polished substrate is, for example, 2.0 Å (0.20 nm) or less, preferably 1.8 Å (0.18 nm) or less, and more preferably 1.5 Å (0.15 nm) or less.

Here, the surface properties of the substrate before subjecting to the polishing step with the polishing composition of the present invention are not particularly limited. For example, a substrate having surface properties such that AFM-Ra is 10 Å (1.0 nm) or less is suitable.

The abrasive usable in the method for manufacturing a substrate of the present invention may be same one as that usable in the above-mentioned polishing composition. The above-mentioned polishing step is carried out in the second or subsequent step among the plural polishing steps, and it is even more preferable to carry out the polishing step as a finish-polishing step.

As described above, the substrate manufactured by using the polishing composition of the present invention or the method for manufacturing a substrate of the present invention has excellent surface smoothness so that a substrate having a surface roughness (AFM-Ra) of, for example, 2.0 Å (0.20 nm) or less, preferably 1.81 (0.18 nm) or less, and more preferably 1.5 Å (0.15 nm) or less may be obtained.

In addition, the manufactured substrate has very small number of nano scratches. Therefore, when the substrate is, for example, a memory hard disk substrate, the substrate can meet the requirement of a recording density of 120 G bits/inch², and preferably 160 G bits/inch². And when the substrate is a semiconductor substrate, the substrate can meet the requirement of a wire width of 65 nm, and preferably 45 nm.

The polishing composition of the present invention can be produced in the manner as described above, or the polishing composition can be economically produced according to the production method described hereinbelow without impairing its productivity.

Therefore, the present invention also relates to a process for producing a polishing composition capable of economically producing the polishing composition.

### Embodiment 2 of the Present Invention

The feature of the process for producing a polishing composition of the present invention resides in that the process is a process for producing the above-mentioned polishing composition, including the following purification steps of:

(I) filtering a pre-purification polishing composition with a depth-type filter, to give an intermediate filtrate; and
(II) filtering the intermediate filtrate with a pleated type filter, to give the polishing composition,
wherein the fluctuation range of the pressure at an inlet of the filter in the step (I) is 50 kPa or less.
According to the polishing composition produced by the process of the present invention, the nano scratches which cause defects can be remarkably reduced, whereby a substrate having excellent surface smoothness can be provided.

As mentioned above, the nano scratches are a property that is an important factor in high densification and high integration in the substrate for a memory hard disk substrate or a semiconductor element. Therefore, by using the above-mentioned polishing composition obtainable in the present invention, a high-quality substrate for a memory hard disk or a semiconductor element having excellent surface properties can be manufactured.

As mentioned above, it has been elucidated that the nano scratches can be reduced by reducing the number of coarse polishing particles having particular sizes existing in the polishing composition. However, in the conventionally known technique, the coarse polishing particles could not be industrially satisfactorily reduced. For example, the step of filtering with a screen type filter such as a membrane filter cannot be used on an industrial scale even though the aggregates of the polishing particles or coarse polishing particles can be removed. In addition, in the step of filtering only with the pleated type filter, while the removal of the aggregate of the polishing particles or coarse polishing particles is satisfactory, clogging is generated by the coarse particles, thereby making it difficult to economically obtain a purified polishing composition.

In the present invention, there is exhibited an effect that a polishing composition capable of remarkably reducing the nano scratches can be economically obtained by filtering first with a depth-type filter, and thereafter with a pleated type filter, and adjusting the fluctuation range of the pressure at an inlet of the depth-type filter to a specified range.

Here, in the filtration with a filter, when an effective sieve opening of the filter material is widened due to pressure, the coarse particles captured or to be captured undesirably pass through the filter, or on the other hand, the detachment of the material of filter (fiber or the like) due to pressure may lead to lowering of the filtration precision. In order to prevent these phenomena, the controlling the pressure difference between the pressures at an inlet and at an outlet of the filter to a given value or lower is generally recommended by the various filter manufacturers. However, even when the pressure difference is controlled to a given value or lower, the lowering of the filtration precision incurred. In view of the above, the present inventors have intensively progressed in the study. As a result, the present inventors have found that the pulsating movement of liquid is generated during the liquid conveying, the fluctuation range of the pressure at an inlet of the filter is widened, thereby causing lowering of the filtration precision.

Therefore, the present inventors have further intensively progressed in the study. As a result, the capturing efficiency of the coarse particles and precision of the filter can be increased in the step for producing a polishing composition by carrying out filtration first with a depth-type filter, and then with a pleated type filter, and controlling the fluctuation range of the pressure at an inlet of the depth-type filter within a given range, whereby the present inventors have found for the first time that even a polishing composition in which the amount of the coarse particles is very strictly controlled as in the present invention can be produced.

In the present invention, the fluctuation range of the pressure at an inlet of the depth-type filter refers to a difference between the maximum pressure and the minimum pressure applied to the filter during liquid conveying. When plural depth-type filters are used, the fluctuation range refers to a value of the depth-type filter positioned at the most upstream.

The fluctuation range of the pressure at an inlet of the depth-type filter in step (I) is 50 kPa or less, and the fluctuation range is preferably 40 kPa or less, and more preferably 30 kPa or less, from the viewpoint of reducing the load of removing the coarse particles in the step (II) due to increase in the filtration precision of the step (I). The fluctuation range of the pressure at an inlet of the filter can be determined by reading off the maximum pressure and the minimum pressure during liquid conveying using, for example, a pressure gauge attached to a filter housing.

As one method of reducing the above-mentioned fluctuation range of the pressure, a method of reducing pulsation generated from the liquid conveying pump including, for example, a method of conveying liquid with a non-pulsating pump having small pulsation, or a method of setting a pressure absorbing device such as damper at an outlet of the pump for preventing pulsation can be used. Alternatively, a method of increasing the volume of the pipe in order to reduce the pulsation of the substance to be filtered between the liquid conveying pump and the inlet of the filter including, for example, a method of setting an accumulator or the like between the outlet of the pump and the filter, a method of extending the length of the pipe between the pump and the filter, or a method of widening the pipe diameter can be used. In addition, the fluctuation range of the pressure can be even made smaller by using each of these methods alone or in a proper combination of them according to a filtration apparatus and filtration conditions and the like.

In the purification step of the polishing composition, the depth-type filter in the step (I) may be the same ones as those used during the control of the content of the coarse particles in the above-mentioned polishing composition.

In the step (I), the depth-type filter may be used in a single step or multi-steps in a combination thereof (for example, in serial arrangement). In addition, the bag style and cartridge style depth-type filters may be used in combination. In the multi-step filtration, the appropriate pore size of the filter and the structure of the filter material are properly selected depending upon the number of polishing particles having particle sizes of 0.56 μm or more and less than 1 μm in the pre-purification polishing composition, and the order of treatment of the filter is properly selected, whereby the particle size control (filtration precision) of the removed coarse particles and economic advantages can be improved. In other words, when a filter having a large pore structure is used in a step (upstream side) earlier than a filter having a finer pore structure, there is an effect that the life of the filter can be extended in the overall production steps.

As the pleated type filter in the step (II), one produced by forming a filter material into a pleated form to give a hollow cylindrical cartridge style filter (one commercially available from Advantec Toyo Kaisha, Ltd., Nihon Pall Ltd., CUNO Incorporated, Daiwabo Co., Ltd. or the like) can be generally used.

The pleated type filter usable in the step (II) may be used in a single step or multi-steps in a combination thereof (for example, in serial arrangement). In the multi-step filtration, the appropriate pore size of the filter and the structure of the filter material are properly selected depending upon the number of polishing particles having particle sizes of 0.56 μm or more and less than 1 μm in the intermediate filtrate after the step (I), and the order of treatment of the filter is properly selected, whereby the productivity of the polishing composition of the present invention can be improved. In other words, when a filter having a large pore structure is used in a step (upstream side) earlier than a filter having a finer pore structure, the life of the filter can be extended overall. Further, when plural filters having the same pore size are used in later step of multi-steps, there is an effect that the quality of the polishing composition can be stabilized.

In the overall filtration steps, when the filtration is carried out first with the depth-type filter, and thereafter with the pleated type filter, the life of the filter can be extended overall, whereby the polishing composition in the present invention can be produced economically advantageously.

The pore sizes of these depth-type filter and pleated type filter are generally expressed as a precision of filtration capable of 99% removal, for example, the pore size of 1.0 μm refers to a filter capable of removing particles having a diameter of 1.0 μm at a ratio of 99%.

The depth-type filter usable in the step (I) of the present invention has a pore size of preferably 5.0 μm or less, more preferably 3.0 μm or less, and even more preferably 2.0 μm or less, from the viewpoint of reducing loads of removing coarse particles in the step (II).

In addition, in the case where plural depth-type filters are used in the step (I) (m, for example, serial arrangement), when a final filter has a pore size in the order of submicron or less, the loads of removing coarse particles in the step (II) are more reduced, thereby improvement in the productivity can be achieved.

The pleated type filter usable in the step (II) in the present invention has a pore size of preferably 1.0 μm or less, more preferably 0.8 μm or less, even more preferably 0.6 μm or less, and even more preferably 0.5 μm or less, from the viewpoint of reducing the content of coarse particles.

The number of the polishing particles having particle sizes of 0.56 μm or more and less than 1 μm per 1 cm³ in the intermediate filtrate after the step (I) is preferably 1,000,000 or less, and the number is more preferably 800,000 or less, even more preferably 700,000 or less, and even more preferably 600,000 or less, from the viewpoint of reducing the loads of removing coarse particles in the step (II).

The number of the polishing particles having particle sizes of 0.56 μm or more and less than 1 μm per 1 cm³ in the polishing composition after the step (II) is 500,000 or less, and the number is preferably 400,000 or less, even more preferably 300,000 or less, even more preferably 200,000 or less, and even more preferably 100,000 or less, from the viewpoint of reducing nano scratches.

As the filtration methods in the step (I) and the step (II), the same filtration method as the filtration method usable during the control of the content of the coarse particles in the above-mentioned polishing composition can be used. In a pressure filtration method in which an air pressure or the like is introduced into a tank, the fluctuation range of the pressure at an inlet of the filter can be reduced.

In the intermediate filtrate to be supplied in the step (II), the number of polishing particles having sizes of 0.56 μm or more and less than 1 μm is preferably 1,000,000 or less per 1 cm³. In order to realize this, besides passing through the step (I), a general dispersion or particle removal step may be provided before and/or after the step (I). For example, a dispersion method using a high-speed dispersion device or a high-pressure dispersion device such as a high-pressure homogenizer, a precipitation method with a centrifuge or the like can be utilized. When these methods are used, the methods may be used alone or in combination of two or more kinds, and the order of the methods (treatments) in the combination is not limited in any way. In addition, the treatment conditions and the number of treatments can be properly selected.

As the supplying pressure to the filter in the step (I) and the step (II), it is preferable that the filtration is carried out at a pressure or lower than that recommended by the manufacturers for the filter used, from the viewpoint of filtration precision. In addition, by making the pressure difference between the pressures at the inlet and at the outlet of the filter larger, the effective sieve opening of the filter material is widened, which leads to lowering the filtration precision. Therefore, it is preferable that the pressure difference is controlled at a given value or less.

The pressure difference of the depth-type filter in the step (I) is preferably 200 kPa or less, more preferably 170 kPa or less, and even more preferably 150 kPa or less, from the viewpoint of filtration precision. The pressure difference of the pleated type filter in the step (II) is preferably 250 kPa or less, more preferably 200 kPa or less, and even more preferably 170 kPa or less, from the viewpoint of filtration precision. Here, using, for example, a pressure gauge attached to a filter housing at the inlet and the outlet, the pressure difference applied to the filter during the liquid conveying can be calculated from a difference of their averages.

Here, the filtration conditions other than those mentioned above in the steps (I) and (II) are not particularly limited.

The pre-purification polishing composition in the present invention refers to a composition containing an abrasive containing polishing particles, before being supplied to the above-mentioned step (I). The pre-purification polishing composition includes, for example, a composition prepared by mixing an abrasive, water, and other components as occasion demands. In addition, the pre-purification polishing composition is preferably in a state in which the polishing particles are dispersed.

In the present invention, a polishing composition can be produced by subjecting the pre-purification polishing composition to steps (I) and (II). Specifically, a polishing composition can be produced by subjecting a composition prepared by mixing an abrasive, water, and other components to the steps (I) and (II); or produced by subjecting the pre-purification polishing composition containing an abrasive and water to the steps (I) and (II) to give a filtrate, and thereafter mixing other components to the filtrate.

In addition, since the present invention is a process for producing the above-mentioned polishing composition, the abrasive, the polishing particles and water, and their contents usable in the present invention may be the same as the abrasive, the polishing particles and water, and their contents usable in the above-mentioned polishing composition.

In the present invention, an acid or a salt thereof, or an alkali which can be used in the pH adjustment of the polishing composition may be the same ones as those used in the pH adjustment of the above-mentioned polishing composition. Further, other components which may be the same components as those that can be formulated in the above-mentioned polishing composition as occasion demands can be formulated.

Examples of the polishing composition after the step (II) produced in the present invention include, for example, the polishing compositions (Embodiments 1 to 7) in the above-mentioned polishing compositions.

In the present invention, the polishing composition after the step (II) satisfies the following conditions (2):

(2) that the ratio of polishing particles having sizes of 1 μm or more is 0.001% by weight or less to the entire polishing particles in the polishing composition, and it is preferable that the polishing composition further satisfies the following conditions (3):
(3) that the ratio of polishing particles having sizes of 3 μm or more is 0.0008% by weight or less to the entire polishing particles in the polishing composition, from the viewpoint of reducing nano scratches.

The above-mentioned polishing composition obtained by the process of the present invention can be used in the manner as described above.

Here, the surface properties of the substrate before subjecting to a polishing step using the polishing composition after the step (II) of the present invention are not particularly limited, and, for example, a substrate having surface properties such that AFM-Ra is 10 Å (1 nm)) or less is preferable.

The substrate manufactured using the polishing composition obtained by the process of the present invention has excellent surface properties, so that a substrate having a surface roughness (AFM-Ra) of 2.0 Å (0.20 nm) or less, preferably 1.8 Å (0.18 nm) or less, and more preferably 1.5 Å (0.15 nm) or less can be obtained.

Further, the substrate manufactured by using the polishing composition obtained by the process of the present invention has very small number of nano scratches. Therefore, when the substrate is, for example, a memory hard disk substrate, the substrate can meet the requirement of a recording density of 120 G bits/inch², and preferably 160 G bits/inch². And when the substrate is a semiconductor substrate, the substrate can meet the requirement of a wire width of 65 nm, and preferably 45 nm.

In addition, the above-mentioned polishing particle preparations (Embodiments A-1 to A-7) can be produced economically advantageously in the same manner as in the process for producing the polishing composition of the present invention without impairing the productivity.

Therefore, the present invention also relates to a process for producing a polishing particle preparation capable of economically advantageously producing the above-mentioned polishing particle preparation.

The feature of the process for producing a polishing particle preparation of the present invention resides in that the process includes the following purification steps of:

(I′) filtering a pre-purification polishing particle preparation with a depth-type filter, to give an intermediate filtrate; and
(II′) filtering the intermediate filtrate with a pleated type filter, to give the polishing particle preparation,
wherein the fluctuation range of the pressure at an inlet of the depth-type filter in the step (I′) is 50 kPa or less.

The fluctuation range of the pressure at an inlet of the depth-type filter in the step (I′) is 50 kPa or less, and the fluctuation range of the pressure is preferably 40 kPa or less, and more preferably 30 kPa or less, from the viewpoint of reducing the loads of removing coarse particles in the step (II′) due to improvement in the filtration precision of the step (I′). The determination method for the fluctuation range of the pressure at an inlet of the filter, and the method of reducing the fluctuation range of the pressure may be the same as those of the above-mentioned process for producing the polishing composition.

In the purification step of the polishing particle preparation, the filter to be used and the embodiments of use of the filter may be the same as those of the above-mentioned process for producing the polishing composition.

The number of polishing particles having sizes of 0.56 mm or more and less than 1 μm is preferably 1,000,000 or less per 1 cm³ of the intermediate filtrate obtained after the step (I′), and the number of polishing particles is more preferably 800,000 or less, even more preferably 700,000 or less, and even more preferably 600,000 or less, from the viewpoint of reducing the loads of removing coarse particles in the step (II′).

The number of polishing particles having sizes of 0.56 μm or more and less than 1 μm is 500,000 or less per 1 cm³ of the polishing particle preparation obtained after the step (II′), and the number of polishing particles is preferably 400,000 or less, more preferably 300,000 or less, even more preferably 200,000 or less, and even more preferably 100,000 or less, from the viewpoint of reducing the nano scratches.

In addition, the ratio of polishing particles having sizes of 1 μm or more is 0.001% by weight or less to the entire polishing particles in the polishing particle preparation after the step (II′), and the ratio is preferably 0.0008% by weight or less, more preferably 0.0007% by weight or less, even more preferably 0.0006% by weight or less, and even more preferably 0.0005% by weight or less, from the viewpoint of reducing the nano scratches.

In addition, the ratio of polishing particles having sizes of 3 μm or more is, for example, 0.0008% by weight or less to the entire polishing particles in the polishing particle preparation after the step (II′), and the ratio is preferably 0.0007% by weight or less, more preferably 0.0006% by weight or less, even more preferably 0.0005% by weight or less, and even more preferably 0.0004% by weight or less, from the viewpoint of reducing the nano scratches.

The number of polishing particles having sizes of 0.56 μm or more and less than 1 μm is preferably 1,000,000 or less per 1 cm³ of the intermediate filtrate supplied to the step (II′), and in order to realize this, besides subjecting to the step (I′), a general dispersion or particle removal step may be provided before and/or after the step (I′) in the same manner as in the above-mentioned process for producing the polishing composition.

Here, the filtration methods and the filtration conditions in the steps (I′) and (II′) may be the same as those in the above-mentioned process for producing the polishing composition

The pre-purification polishing particle preparation usable in the present invention refers to an aqueous dispersion of an abrasive before being supplied to the above-mentioned step (I′). The abrasive and water may be the same ones as those usable in the above-mentioned polishing composition. In addition, the pre-purification polishing particle preparation is preferably in the state in which the polishing particles are dispersed.

In the present invention, the above-mentioned polishing particle preparations (Embodiments A-1 to A-7) can be produced economically advantageously by subjecting the pre-purification polishing particle preparation to the steps (I′) and (II′). The polishing particle preparation can be used in the preparation of the above-mentioned polishing composition.

The present invention further relates to a method for manufacturing a substrate including the step of polishing a substrate for precision parts such as memory hard disks and semiconductor elements, wherein the above-mentioned nano scratches which are an important factor in high densification are remarkably reduced, and the substrate can be polished economically.

### Embodiment 3 of the Present Invention

The feature of the method for manufacturing a substrate of the present invention resides in that the method includes the step of polishing a substrate to be polished while feeding the polishing composition mentioned above to the polishing machine containing a platen at a flow rate of 0.06 cm³/minute or more per 1 cm² of an area to be polished of the substrate. Therefore, the nano scratches which cause defects can be remarkably reduced, so that a substrate having excellent surface smoothness can be provided. As mentioned above, the nano scratches are a property that is an important factor in high densification and high integration in the substrate for a memory hard disk or a semiconductor element. Therefore, by using the method for manufacturing a substrate of the present invention, a high-quality substrate for a memory hard disk or a semiconductor element having excellent surface properties can be manufactured.

It is elucidated in the present invention that the nano scratches can be reduced by controlling the polishing pressure during polishing with the above-mentioned polishing composition.

The polishing composition usable in the present invention may be the above-mentioned polishing composition. Among them, the polishing composition as described below is preferable.

Specifically, the number of polishing particles having sizes of 0.56 μm or more and less than 1 μm in the polishing composition is preferably 300,000 or less, more preferably 200,000 or less, even more preferably 100,000 or less, and even more preferably 10,000 or less, from the viewpoint of reducing nano scratches.

Also, the ratio of the polishing particles having sizes of 1 μm or more to the entire polishing particles in the polishing composition is preferably 0.0008% by weight or less, more preferably 0.0007% by weight or less, even more preferably 0.0006% by weight or less, and even more preferably 0.0005% by weight or less, from the viewpoint of reducing nano scratches.

In addition, the ratio of the polishing particles having sizes of 3 μm or more to the entire polishing particles in the polishing composition is preferably 0.0008% by weight or less, more preferably 0.0007% by weight or less, even more preferably 0.0006% by weight or less, even more preferably 0.0005% by weight or less, and even more preferably 0.0004% by weight or less, from the viewpoint of reducing nano scratches.

In order to reduce the number of polishing particles having sizes of 0.5 μm or more and less than 1 μm, the filtration or the like with a filter is effective. For example, when a pleated type filter having high filtration precision of a pore size of 0.45 μm is used, the nano scratches can be reduced. Further, the platen pressure during the polishing is adjusted to 3 to 50 kPa in order to avoid the penetration of the aggregates of polishing particles or coarse polishing particles that may cause the nano scratches into a space between the substrate and polishing pad, whereby there is an advantage that the nano scratches can be remarkably reduced.

As the filter material for the precision filtration, a depth-type filter or a pleated type filter can be used. The depth-type filter includes, for example, ones usable in the control of the content of the coarse particles in the above-mentioned polishing composition.

The filtration method may be same as the filtration method in the above-mentioned polishing composition. Further, in consideration of economic advantages, a depth-type filter having a pore size larger than that of a pleated type filter can be used prior to the pleated type filter. The depth-type filter has a pore size of preferably 10 μm or less, more preferably 5 μm or less, and even more preferably 3 μm or less. The pleated type filter has a pore size of preferably 1 μm or less, more preferably 0.8 μm or less, even more preferably 0.6 μm or less, and even more preferably 0.5 μm or less.

The content of the abrasive in the polishing composition is, for example, 1% by weight or more, preferably 3% by weight or more, more preferably 5% by weight or more, and even more preferably 7% by weight or more, from the viewpoint of occurrences of the nano scratches due to polishing vibration. Also, the content is for example, 20% by weight or less, preferably 15% by weight or less, more preferably 13% by weight or less, and even more preferably 10% by weight or less, from the viewpoint of economic advantages. In other words, the content is, for example, from 1 to 20% by weight, preferably from 3 to 15% by weight, more preferably from 5 to 13% by weight, and even more preferably from 7 to 10% by weight. These content may be any content during the production of the polishing composition and the content upon use. In many cases, the polishing composition is usually prepared as a concentrate, which is diluted upon use.

The abrasive may be the abrasive usable in the above-mentioned polishing composition. Among them, aluminum oxide, fumed silica, colloidal silica, cerium oxide, zirconium oxide, titanium oxide and the like are suitable for polishing a substrate for precision parts such as a semiconductor wafer or semiconductor element, or a substrate for magnetic recording medium.

The shape of the abrasive is preferably spherical colloidal particles, in order to increase the packing density of the abrasive, thereby obtaining a smooth surface. Further, colloidal cerium oxide particles, colloidal silica particles, surface-modified colloidal silica particles, and the like are preferable, and the colloidal silica particles are even more preferable, from the viewpoint of reducing nano scratches which cause surface defects. Here, the colloidal silica particles can be obtained by a process of generating silica particles from, for example, an aqueous silicic acid solution. The colloidal silica is suitable for finish polishing a substrate for a high-recording density memory magnetic disk, preferably a substrate for a memory hard disk, requiring an even higher degree of smoothness, and also suitable for preferably final polishing use, or polishing use for a semiconductor device substrate.

The balance of the polishing composition is water. The content thereof is not particularly limited.

In addition, the polishing composition may at least contain an abrasive and water. Components such as an acid, a salt, and an oxidizing agent may be contained from the viewpoint of giving the desired action.

The pH of the polishing composition usable in the present invention is from 0.1 to 7. When the pH exceeds 7, in the case where the colloidal silica is used as an abrasive, the nano scratches increase. In general, the polishing of the substrate is established by a balance between physical polishing power and chemical polishing power. Specifically, the substrate surface is corroded by the chemical polishing power, thereby making it easier to grind the substrate, and the corroded portion is scraped off by physical polishing power, whereby the polishing progresses. For example, in the case of a Ni-P plated substrate, when the pH exceeds 7, the chemical polishing power becomes very weak, so that the physical polishing power becomes dominant, whereby not only the number of nano scratches become larger, but also the polishing rate is dramatically lowered.

The pH of the polishing composition is preferably 5 or less, and more preferably 4 or less, from the viewpoint of increasing the polishing rate, and the pH is 0.1 or more, preferably 0.5 or more, more preferably 1 or more, and even more preferably 1.4 or more, from the viewpoint of influence to human bodies and corrosion of machines. Even more preferably, in the substrate for working precision parts which are a metal of a nickel-phosphorus (Ni-P)-plated aluminum alloy substrate, the pH is preferably 4.5 or less, and more preferably 3.5 or less. Therefore, the pH may be adjusted in accordance with the purposes that are respected. Even more preferably, in the substrate for working precision parts which are a metal of a nickel-phosphorus (Ni-P)-plated aluminum alloy substrate, the pH is preferably from 0.1 to 6, more preferably 1 to 4.5, and even more preferably from 1.4 to 3.5, from the above-mentioned viewpoints.

Further, the difference between the pH of the polishing composition before polishing and the pH of the polishing waste liquid after polishing is preferably 2 or less, more preferably 1 or less, and even more preferably 0.5 or less. Here, the polishing composition before polishing refers to a polishing composition before supplying to a polishing surface, and the polishing waste liquid after polishing refers to a waste liquid of the polishing liquid after supplying the polishing composition to the substrate and polishing. When the fluctuation of the above-mentioned pH is large, the abrasive particles contained in the polishing composition are likely to be aggregated during polishing, and the aggregates can be the causing substances of the nano scratches. On the other hand, when the pH difference is adjusted to 2 or less, the aggregation of the abrasive grains is more likely to be suppressed, so that a substrate having reduced nano scratches can be more suitably manufactured.

In order to adjust the above-mentioned pH difference to 2 or less, the flow rate of the polishing composition, for example, can be adjusted. When a polishing composition giving a large pH difference is used, the pH difference can be controlled by making the flow rate large.

The flow rate of the polishing composition supplied to the polishing machine is 0.06 cm³/minute or more, per 1 cm² of an area to be polished of the substrate. When the flow rate is less than 0.06 cm³/minute, vibration of the polishing machine is generated due to a large frictional resistance, thereby undesirably increasing the gap between the polishing side of the substrate and the polishing pad, whereby the aggregates of the polishing particles are penetrated between the gap to cause increase in the number of nano scratches. The flow rate is preferably 0.09 cm³/minute or more, more preferably 0.12 cm³/minute or more, and even more preferably 0.15 cm³/minutes or more, from the viewpoint of occurrences of nano scratches due to polishing vibration, and the flow rate is preferably 0.46 cm³/minute or less, more preferably 0.30 cm³/minute or less, and even more preferably 0.23 cm³/minute or less, from the viewpoint of economic advantages. In addition, the flow rate is preferably from 0.09 to 0.46 cm³/minute, more preferably from 0.12 to 0.30 cm³/minute, and even more preferably from 0.15 to 0.23 cm³/minute.

During polishing, the polishing step is carried out by feeding the polishing composition between a polishing pad, such as a nonwoven organic polymer-based polishing pad, and a substrate to be polished, i.e. feeding the polishing composition to the polishing side of the substrate pressed against platens to which the polishing pad is attached, wherein the polishing composition is in contact with the substrate, and moving the platens and/or the substrate, while applying a given pressure.

The platen pressure in the present invention refers to a pressure of the platen applied to the polishing surface of the substrate to be polished during polishing. Although not wanting to be limited by theory, when this platen pressure is adjusted to a range of preferably from 3 to 50 kPa, the gap between the polishing surface of the substrate and the polishing pad is appropriately narrowed, so that it is deduced that aggregates of polishing particles causing the nano scratches are less likely to flow out onto the substrate, thereby reducing the nano scratches. For example, when the platen pressure is adjusted to 3 kPa or more, the aggregates of polishing particles and the like are less likely to be penetrated into the gap between the polishing surface of the substrate and the polishing pad, so that the nano scratches are reduced. In addition, when the platen pressure is adjusted to 50 kPa or less, the vibration of the polishing machine is appropriately maintained due to low frictional resistance, so that the gap between the polishing surface of the substrate and the polishing pad caused by vibration is narrowed, whereby the aggregates of the polishing particles are less likely to be placed between the platens, so that nano scratches are reduced. The platen pressure is preferably 3 kPa or more, more preferably 5 kPa or more, and even more preferably 8 kPa or more, from the viewpoint of productivity. Therefore, the platen pressure is preferably from 5 to 40 kPa, and more preferably from 10 to 30 kPa, from the viewpoint of economically advantageously reducing the nano scratches.

Here, the above-mentioned platen pressure can be adjusted by applying air pressure or a weight to the platen and/or the substrate.

In the above-mentioned polishing step, the substrate to be polished can be polished by feeding the polishing composition to the polishing side of the substrate placed between platens to which a porous organic polymer-based polishing pad is attached, and moving the platens or the substrate, while applying a given load. Other conditions during polishing (kinds of polishing machine, kinds of polishing pad and the like) are not particularly limited. In addition, the method of feeding a polishing composition to a polishing side, the method of moving platens or a substrate and the like may be carried out by known methods.

The materials of the substrate which is an object to be polished suitably used in the present invention may be the same as the material of the object to be polished suitable for the above-mentioned polishing composition.

Effectively, in the method for manufacturing a substrate, the present invention is preferably used in a second or subsequent step in the case where the method includes plural polishing steps including rough polishing step, the present invention is, for example, preferably used in a final polishing step. The substrate manufactured as described above has remarkably reduced nano scratches and excellent surface smoothness.

As described above, by using the method for manufacturing a substrate of the present invention, the occurrences of nano scratches are remarkably reduced, so that a high-quality substrate having excellent surface properties, for example, a substrate for precision parts such as a memory hard disk or a semiconductor element can be suitably manufactured.

### EXAMPLES

The following examples further describe and demonstrate embodiments of the present invention. The examples are given solely for the purposes of illustration and are not to be construed as limitations of the present invention.

### Example I

Polishing was evaluated with a Ni-P-plated aluminum alloy substrate having a thickness of 1.27 mm, an outer diameter of 95 mm and an inner diameter of 25 mm as a substrate to be polished, wherein the substrate was previously roughly polished with a polishing composition containing an alumina abrasive to adjust its AFM-Ra to 10 Å (1 nm).

### Example I-1

As an abrasive, 25 L of colloidal silica slurry (commercially available from DuPont, average particle size of primary particles: 22 nm, a product having a concentration of silica particles: 40% by weight) was filtered with a bag style depth-type filter (commercially available from Sumitomo 3M Limited, Liquid Filter 522), thereafter filtered with a pleated type filter (commercially available from Advantec Toyo Kaisha, Ltd., TCS-E045-S1FE), to give a polishing particle preparation a of Table 1 (Preparation Example 1). The polishing particle preparation a was added while stirring to an aqueous solution prepared by adding given amounts of an aqueous 35% by weight-hydrogen peroxide solution (commercially available from Asahi Denka Co., Ltd.), an aqueous 60% by weight-HEDP (1-hydroxyethylidene-1,1-diphosphonic acid) solution (commercially available from Solutia Japan Limited), and 95% by weight-sulfuric acid (commercially available from Wako Pure Chemical Industries, Ltd.) to ion-exchanged water while mixing, so as to have the concentrations shown in Table 2, to give a polishing composition A.

### Example 1-2

The same procedures as in Example I-1 were carried out except that an HDCII (MCY1001J012H13) commercially available from Nihon Pall Ltd. was used as a pleated type filter, to give a polishing particle preparation b of Table 1 (Preparation Example 2) and a polishing composition B.

### Example 1-3

The same procedures as in Example I-1 were carried out except that Zetapor (70006-01N-120PG) commercially available from CUNO Incorporated was used as a pleated type filter, to give a polishing particle preparation c of Table 1 (Preparation Example 3) and a polishing composition C.

### Example I-4

The same procedures as in Example I-1 were carried out except that a pleated type filter was changed to a filter commercially available from Advantec Toyo Kaisha, Ltd. (TCPD-05A-S1FE), to give a polishing particle preparation d of Table 1 (Preparation Example 4) and a polishing composition D.

### Example I-5

The polishing particle preparation a of Preparation Example 1 was added while stirring to an aqueous solution prepared by adding given amounts of a 60% by weight-aqueous HEDP solution and a 95% by weight-sulfuric acid to ion-exchanged water while mixing, to give a polishing composition E.

### Example I-6

The same procedures as in Example I-1 were carried out except that the pleated type filter was changed to Ultipleat Profile (PUY1UY020H13) commercially available from Nihon Pall Ltd. having an intermediate structure, to give a polishing particle preparation g of Table 1 (Preparation Example 5) and a polishing composition G.

### Example I-7

The polishing particle preparation a of Preparation Example 1 was added while stirring to an aqueous solution prepared by adding given amounts of a 35% by weight-hydrogen peroxide solution, a 60% by weight-aqueous HEDP solution and a 95% by weight-sulfuric acid to ion-exchanged water while mixing, to give a polishing composition I.

### Example I-8

Eighty-six percent of the amount of the ion-exchanged water necessary for the concentration shown in Table 2 was added to the polishing particle preparation a of Preparation Example 1, to prepare a diluted slurry. Separately, an acidic aqueous solution prepared by mixing given amounts of a 35% by weight-hydrogen peroxide solution (commercially available from Asahi Denka Co., Ltd.), a 60% by weight-aqueous HEDP solution (commercially available from Solutia Japan Limited) and a 95% by weight-aqueous sulfuric acid (commercially available from Wako Pure Chemical Industries, Ltd.) with the remaining 14% of the above-mentioned amount of ion-exchanged water was prepared. This acidic aqueous solution was added to the above-mentioned diluted slurry while stirring, to give a polishing composition K.

### Comparative Example I-1

The same procedures as in Example I-1 were carried out except that WAVE STAR (W-004-S-DO-E) commercially available from Daiwabo Co., Ltd. was used as a pleated type filter, to give a polishing particle preparation f of Table 1 (Preparation Example 6) and a polishing composition F.

### Comparative Example I-2

The polishing particle preparation a of Preparation Example 1 was added to ion-exchanged water while stirring so as to have the concentration shown in Table 2, to give a polishing composition H.

### Comparative Example I-3

Colloidal silica slurry (commercially available from Nissan Chemical Industries, Ltd., Snowtex ST-50, average particle size: 30 nm, a product having a concentration of silica particles: 48% by weight) was added to ion-exchanged water while stirring. Furthermore, the mixture was subjected to suction-filtration with a membrane filter made of cellulose acetate (0.45 μm, diameter: 90 mm), to give a polishing composition J.

### Comparative Example I-4

One-hundred and five liters of a colloidal silica slurry (commercially available from DuPont, average particle size of primary particles: 22 nm, a product having a concentration of silica particles: 40% by weight) was prepared, and 100 L of the slurry was filtered with a bag style depth-type filter (commercially available from Sumitomo 3M Limited, “Liquid Filter 522”), and then two-step depth-type cartridge filters (commercially available from Nihon Pall Ltd., RM1F010H21 and RM1F005H21 connected in series). After the colloidal silica slurry was allowed to stand in the filter in a state where the filter was fully packed with the colloidal silica slurry for 3 days, the remaining 5 L of the above-mentioned colloidal silica slurry was filtered in the same manner as above, to give about 5 L of a polishing particle preparation m (Preparation Example 7).

The same procedures as in Example I-1 were carried out except that the polishing particle preparation m was used in place of the polishing particle preparation a, to give a polishing composition M from the polishing particle preparation m.

Using the polishing particle preparations and the polishing compositions obtained in Examples I-1 to I-8 and Comparative Examples I-1 to I-4, the coarse particles, polishing rate and surface roughness were determined or evaluated according to the following conditions and methods, and the nano scratch was also determined or evaluated according to “Nano Scratch Standard Test” described herein. Furthermore, the relative evaluation to the number of the nano scratches of Comparative Example I-1 (number/side) was carried out as the evaluation of the nano scratches. Here, the polishing rate and the surface roughness are values under the polishing conditions for Nano Scratch Standard Test. The results obtained are shown in Table 2.

### [Measurement Conditions for Polishing Particles]

Measuring Instrument: “Accusizer 780APS,” commercially available from Particle Sizing Systems (PSS)
Injection Loop Volume: 1 ml
Flow Rate: 60 mL/min.
Data Collection Time: 60 sec.
Number Channels: 128

### [Determination Conditions for Polishing Rate]

The polishing rate per unit time (μm/min) was calculated by dividing a weight difference (g) between an object to be polished and the object after polishing by the density (8.4 g/cm³) of the object, and further dividing the resultant quotient by the surface area (65.97 cm²) of the disk and the polishing time period (min.).

### [Method for Evaluating Surface Roughness (AFM-Ra)]

Measuring Instrument: “TM-M5E,” commercially available from Veeco
Mode: non-contact
Scan rate: 1.0 Hz
Scan area: 10×10 μm
Evaluation: Determinations for the average surface roughness (AFM-Ra) were taken on three points equidistant from both the inner circumference and the outer circumference of the disk on both the sides per one disk in a circumferential direction every 120°, and an average of the total of 6 points was obtained.

TABLE 1

| | | Polishing Particles in Polishing Particle Preparation | | | |
|---|---|---|---|---|---|
| | | Average | Number of Polishing Particles | Concentration of Particles | Concentration of Particles |
| | Polishing | Particle | Having Sizes of 0.56 μm or | Having Sizes of 1 μm or More | Having Sizes of 3 μm or More |
| Prep. | Particle | Size | More and Less Than 1 μm | to Entire Polishing Particles | to Entire Polishing Particles |
| Ex. No. | Preparation | (nm) | (number/cm³) | (% by weight) | (% by weight) |
| 1 | a | 22 | 23,500 | 0.000037 | 0.000035 |
| 2 | b | 22 | 154,000 | 0.000104 | 0.000098 |
| 3 | c | 22 | 281,000 | 0.000032 | 0.000029 |
| 4 | d | 22 | 403,000 | 0.000116 | 0.000108 |
| 5 | g | 22 | 341,000 | 0.000146 | 0.000145 |
| 6 | f | 22 | 934,000 | 0.000024 | 0.000010 |
| 7 | m | 22 | 340,000 | 0.001180 | 0.001160 |

TABLE 2

| | Polishing Composition | | | | | | | | |
|---|---|---|---|---|---|---|---|---|---|
| | Abrasive | | | | | | | | |
| | | Number of Polishing | | | | | | | |
| | | Particles Having | Concentration¹⁾ of | | Content¹⁾ | | | | |
| | | Sizes of 0.56 μm or | Particles Having | Concentration¹⁾ of | of | | | | |
| | | More | Sizes of 1 μm or | Particles Having Sizes of | Entire | | | | |
| | | and Less Than 1 μm | More to Entire | 3 μm or More to Enti | Polishing | Hydrogen | | Sulfuric | |
| | Kind | (number/cm³) | Polishing Particles | Polishing Particles | Particles | Peroxide¹⁾ | HEDP¹⁾ | Acid¹⁾ | pH |
| Ex. No | | | | | | | | | |
| I-1 | A | 29,600 | 0.000248 | 0.000223 | 7.0 | 0.6 | 0.13 | 0.4 | 1.4 |
| I-2 | B | 194,000 | 0.000525 | 0.000450 | 7.0 | 0.6 | 0.13 | 0.4 | 1.4 |
| I-3 | C | 354,000 | 0.000162 | 0.000135 | 7.0 | 0.6 | 0.13 | 0.4 | 1.4 |
| I-4 | D | 487,000 | 0.000585 | 0.000495 | 7.0 | 0.6 | 0.13 | 0.4 | 1.4 |
| I-5 | E | 32,500 | 0.000124 | 0.000098 | 7.0 | — | 0.13 | 0.4 | 1.4 |
| I-6 | G | 430,000 | 0.000981 | 0.000924 | 7.0 | 0.6 | 0.13 | 0.4 | 1.4 |
| I-7 | I | 36,400 | 0.000166 | 0.000148 | 7.0 | 0.6 | 0.03 | 0.1 | 5.0 |
| I-8 | K | 38,500 | 0.000322 | 0.000290 | 7.0 | 0.6 | 0.13 | 0.4 | 1.4 |
| Comp. | | | | | | | | | |
| Ex. No. | | | | | | | | | |
| I-1 | F | 1,176,000 | 0.000161 | 0.000064 | 7.0 | 0.6 | 0.13 | 0.4 | 1.4 |
| I-2 | H | 90,000 | 0.000086 | 0.000069 | 7.0 | — | — | — | 9.6 |
| I-3 | J | 47,600 | 0.000651 | 0.000626 | 24.0 | — | — | — | 9.4 |
| I-4 | M | 418,000 | 0.002370 | 0.002200 | 7.0 | 0.6 | 0.13 | 0.4 | 1.4 |

| | | Number of Nano Scratches | | | |
|---|---|---|---|---|---|
| | | According to Standard Test | | | |
| | Polishing | Relative | | | Surface |
| | Rate²⁾ | Value | (number/side) | (number/cm²) | Roughness³⁾ |
| Ex. No. | | | | | |
| I-1 | 0.14 | 0.26 | 29 | 0.44 | 1.4 |
| I-2 | 0.13 | 0.46 | 51 | 0.77 | 1.4 |
| I-3 | 0.15 | 0.57 | 63 | 0.95 | 1.4 |
| I-4 | 0.14 | 0.70 | 77 | 1.2 | 1.4 |
| I-5 | 0.06 | 0.40 | 44 | 0.67 | 1.4 |
| I-6 | 0.12 | 0.82 | 91 | 1.4 | 1.5 |
| I-7 | 0.04 | 0.81 | 89 | 1.3 | 1.5 |
| I-8 | 0.14 | 0.52 | 57 | 0.86 | 1.4 |
| Comp. | | | | | |
| Ex. No. | | | | | |
| I-1 | 0.14 | 1.00 | 110 | 1.7 | 1.5 |
| I-2 | 0.02 | 22.2 | 2440 | 37 | 1.6 |
| I-3 | 0.02 | 23.5 | 2590 | 39 | 1.4 |
| I-4 | 0.14 | 1.05 | 116 | 1.8 | 1.5 |

¹⁾% by weight
²⁾μm/min
³⁾AFM-Ra (Å, 0.1 nm)

It can be seen from the results shown in Table 2 that the occurrences of nano scratches in the substrates obtained using the polishing compositions of Examples I-1 to I-8 are suppressed as compared to that of Comparative Example I-1 or I-4, and that the polishing rates are excellent and the occurrences of nano scratches are suppressed in the substrates obtained using the polishing compositions of Examples I-1 to I-8 as compared to those of Comparative Example I-2 or I-3.

Furthermore, each of the substrates obtained in Examples I-1 to I-8 has very low surface roughness.

### Example II

Coarse particles and nano scratches were evaluated in the same manner as in Example I using the polishing compositions a′ to i′ obtained in the following Examples II-1 to II-5 and Comparative Examples II-1 to II-4. The results are shown in Table 3.

Furthermore, as an evaluation index for productivity in filtration, in the case where at least 200 kg of a polishing composition could be filtered without clogging, the productivity evaluation is acceptable, and in the case where clogging was formed so that filtration became difficult with 200 kg or less of a polishing composition, the amount of the filtrate up to that point was listed in Table 3.

Here, the differential pressure of the filters in Examples and Comparative Examples was controlled by the flow rate so as to have a pressure of 150 kPa or less in a depth-type filter, or 160 kPa or less in a pleated type filter.

### Example II-1

As a pre-purification polishing composition, a colloidal silica slurry (commercially available from DuPont, average particle size of primary particles: 20 nm, a product having a concentration of silica particles: 40% by weight, the number of polishing particles having sizes of 0.56 μm or more and less than 1 μm: 6,875,000/cm³) was used. Using a diaphragm pump commercially available from Yamada Corporation (model No. DP-10BT) as a pump and a pulsation dumper commercially available from Yamada Corporation (Model No. AD-10ST) at an outlet of the pump, the slurry was conveyed with a 10 m tetoron braided hose (outer diameter: 18 mm, inner diameter: 12 mm) as a pipe. Thereafter, the slurry was filtered with a bag style depth-type filter (commercially available from Sumitomo 3M Limited, “Liquid Filter 522”) directly connected to a pressure gauge in a housing as a filter in the first step and serially placing two “TCP-JX”s commercially available from Advantec Toyo Kaisha, Ltd. (pore size: 1.0 μm) 250 mm in length as pleated type filters in the subsequent step under the conditions that the average flow rate was 10.3 kg/min, to give a polishing composition a. The fluctuation range of the inlet pressure of the depth-type filter was 30 kPa, and clogging was not formed at a point where the amount of the filtrate was 200 kg. The polishing composition a was added to an aqueous solution prepared by adding given amounts of an aqueous 35% by weight-hydrogen peroxide solution (commercially available from Asahi Denka Co., Ltd.), an aqueous 60% by weight-HEDP solution (commercially available from Solutia Japan Limited), and 95% by weight-sulfuric acid (commercially available from Wako Pure Chemical Industries, Ltd.) to ion-exchanged water while stirring, so as to have the concentration shown in Table 3, to give a polishing composition a′.

### Example II-2

The same ones as those used in Example II-1 were used in the same manner for the pre-purification polishing composition, and the diaphragm pump, the dumper, the tetoron braided hose and the bag style depth-type filter. Next to the bag style depth-type filter, using “TCPD-03A” commercially available from Advantec Toyo Kaisha, Ltd. (pore size: 3.0 μm) 250 mm in length as a cartridge style depth-type filter, and two serially placed “TCP-JX”s commercially available from Advantec Toyo Kaisha Ltd. (pore size: 1.0 μm) 250 mm in length as pleated type filters, the pre-purification polishing composition was filtered under the conditions of an average flow rate of 8.1 kg/min, to give a polishing composition b. The fluctuation range of the inlet pressure of the depth-type filter was 35 kPa, and clogging was not formed at a point where the amount of the filtrate was 200 kg. A polishing composition b′ was obtained in the same manner as in Example II-1 using the resulting polishing composition b.

### Example II-3

The same ones as those used in Example II-1 were used in the same manner for the pre-purification polishing composition and the diaphragm pump, the damper, the tetoron braided hose and a bag style depth-type filter. Next to the bag style depth-type filter, using “TCPD-03A” commercially available from Advantec Toyo Kaisha, Ltd. (pore size: 3.0 μm), and “Profile II-010” commercially available from Nihon Pall Ltd. (pore size: 1.0 μm) each being 250 mm in length as cartridge style depth-type filters in this order, and two serially placed “TCYE-HS”s commercially available from Advantec Toyo Kaisha, Ltd. (pore size: 0.65 μm) 250 mm in length as pleated type filters, the pre-purification polishing composition was filtered under the conditions that the average flow rate was 5.2 kg/min, to give a polishing composition c. The fluctuation range of the inlet pressure of the depth-type filter was 32 kPa, and clogging was not formed at a point where the amount of the filtrate was 200 kg. A polishing composition c′ was obtained in the same manner as in Example II-1 using the resulting polishing composition c.

### Example II-4

The same ones as those used in Example II-1 were used in the same manner for the pre-purification polishing composition and the diaphragm pump, the damper, the tetoron braided hose and the bag style depth-type filter. Next to the bag style depth-type filter, using “Profile II-020” commercially available from Nihon Pall Ltd. (pore size: 2.0 μm) and “Profile II-005” commercially available from Nihon Pall Ltd. (pore size: 0.5 μm) each being 250 mm in length in this order as cartridge style filters, and two serially placed “TCYE-HS”s commercially available from Advantec Toyo Kaisha, Ltd. (pore size: 0.65 μm) 250 mm in length as pleated type filters, the pre-purification polishing composition was filtered under the conditions of an average flow rate of 6.4 kg/min, to give a polishing composition d. The fluctuation range of the inlet pressure of the depth-type filter was 21 kPa, and clogging was not formed when the amount of the filtrate was 200 kg. A polishing composition d′ was obtained in the same manner as in Example II-1 using the resulting polishing composition d.

### Example II-5

The same ones as those used in Example II-1 were used in the same manner for the pre-purification polishing composition and the diaphragm pump, the damper, the tetoron braided hose and the bag style depth-type filter. As a step of obtaining an intermediate filtrate, the pre-purification polishing composition was first filtered with a bag style depth-type filter under the conditions that the average flow rate was 15.3 kg/min. The fluctuation range of the inlet pressure of the depth-type filter was 39 kPa, and the amount of the filtrate was 250 kg. The resulting primary filtrate was treated using a KS TYPE SUPER HIGH SPEED CENTRIFUGE (commercially available from KANSAI CENTRIFUGAL SEPARATOR MFG. CO., LTD., model No. U1-160, rotational cylinder size: 105 mm diameter, 730 mm height, maximum holding solid content: about 6 L), under the conditions of a rotational speed of 18500 r/min, centrifugal acceleration: 20000 G, average flow rate: 12.5 kg/min. This intermediate filtrate was placed in a pressurizable 1M³-stainless tank, and two “TCP-JX”s commercially available from Advantec Toyo Kaisha, Ltd. (pore size: 1.0 μm) 250 mm in length were serially set as pleated type filters in the outlet-line of the tank. The intermediate filtrate was filtered under the pressurization conditions of 1.7 kg/cm², to give a polishing composition e. Clogging was not formed when the amount of the filtrate was 200 kg. A polishing composition e′ was obtained in the same manner as in Example II-1 using the resulting polishing composition e.

### Comparative Example II-1

The same ones as those used in Example II-1 were used for the pre-purification polishing composition and the bag style depth-type filter. Using a 2-m tetoron braided hose (outer diameter: 18 mm, inner diameter: 12 mm) as a pipe, the pre-purification polishing composition was conveyed to a diaphragm pump commercially available from Yamada Corporation (model No. DP-10BT) and a depth-type filter. Next to the bag style depth-type filter, using two serially placed “TCP-JX”s commercially available from Advantec Toyo Kaisha, Ltd. (pore size: 1.0 μm) 250 mm in length as pleated type filters, the pre-purification polishing composition was filtered under the conditions that the average flow rate was 12.6 kg/min, to give a polishing composition f. The fluctuation range of the inlet pressure of the depth-type filter was 75 kPa, and clogging was not formed when the amount of the filtrate was 200 kg. A polishing composition f′ was obtained in the same manner as in Example II-1 using the resulting polishing composition f.

### Comparative Example II-2

The same ones as those used in Example II-1 were used in the same manner for the pre-purification polishing composition and the diaphragm pump, the damper, the tetoron braided hose and the bag style depth-type filter. The pre-purification polishing composition was filtered with a bag style depth-type filter alone under the conditions that the average flow rate was 13.5 kg/min, to give a polishing composition g. The fluctuation range of the inlet pressure of the depth-type filter was 50 kPa, and clogging was not formed when the amount of the filtrate was 200 kg. A polishing composition g′ was obtained in the same manner as in Example II-1 using the resulting polishing composition g.

### Comparative Example II-3

The same ones as those used in Example II-1 were used in the same manner for the pre-purification polishing composition and the diaphragm pump, the damper, and the tetoron braided hose. Using two serially set “TCP-JX”s commercially available from Advantec Toyo Kaisha, Ltd. (pore size: 1.0 μm) 250 mm in length as pleated type filters, the pre-purification polishing composition was filtered under the conditions that the average flow rate was 8.9 kg/min, to give a polishing composition h. The fluctuation range of the inlet pressure of the pleated type filter was 45 kPa, and clogging was formed when the amount of the filtrate was 43 kg. A polishing composition h′ was obtained in the same manner as in Example II-1 using the resulting polishing composition h.

### Comparative Example II-4

The same ones as those used in Example II-1 were used in the same manner for the pre-purification polishing composition and the diaphragm pump, the damper, and the tetoron braided hose. Using two serially set “TCYE-HS”s commercially available from Advantec Toyo Kaisha, Ltd. (pore size: 0.65 μm) 250 mm in length as pleated type filters, the pre-purification polishing composition was filtered under the conditions that the average flow rate was 7.5 kg/min, to give a polishing composition i. The fluctuation range of the inlet pressure of the pleated type filter was 61 kPa, and clogging was formed when the amount of the filtrate was 20 kg. A polishing composition i′ was obtained in the same manner as in Example II-1 using the resulting polishing composition i.

TABLE 3

| | | | | | | | | | | | | | Conc. of | Conc. of | |
|---|---|---|---|---|---|---|---|---|---|---|---|---|---|---|---|
| | | | | | | | | | | | | | polishing | polishing | |
| | | | | | | | | | | | No. of | No. of | particles | particles | |
| | | | | | | | | | | | Polishing | polishing | Having | Having | |
| | | | | | | | | | | | Particles | particles | Sizes of | Sizes of | |
| | | | | | | | | | | | Having | Having | 1 μm or | 3 μm or | |
| | | | | | | | | | | | Sizes of | Sizes of | more to | more to | |
| | | | | | | | | | | | 0.56 μm | 0.56 μm | Entire | Entire | |
| | | | | | | | Number | | | | or more | or more | Polishing | Polishing | |
| | | | | | | | of | | Fluctuation | | and less | and less | Particles | Particles | |
| | | | | | | | Pleated | | Range | Average | than 1 μm | than 1 μm | After | After | |
| | Number of | | | | | | Type | | of | Flow | Before | After | Step II | Step II | Productivity |
| | Depth Filter | | | | | | Filter | | Pressure | Rate | Step II | Step II | (% by | (% by | (amount of |
| | A | B | C | E | F | Centrifugation | G | H | (kPa) | (kg/min) | (#/cm³) | (#/cm³) | weight) | weight) | filtration/kg) |
| Ex. No. | | | | | | | | | | | | | | | |
| II-1 | 1 | | | | | | 2 | | 30 | 10.3 | 985,000 | 436,000 | 0.000598 | 0.000412 | >200 |
| II-2 | 1 | 1 | | | | | 2 | | 35 | 8.1 | 685,000 | 241,000 | 0.000284 | 0.000108 | >200 |
| II-3 | 1 | 1 | | 1 | | | | 2 | 32 | 5.2 | 498,000 | 95,600 | 0.000301 | 0.000214 | >200 |
| II-4 | 1 | | 1 | | 1 | | | 2 | 21 | 6.4 | 395,000 | 67,300 | 0.000364 | 0.000154 | >200 |
| II-5 | 1 | | | | | 1 | 2 | | 39 | 15.3 | 754,000 | 386,000 | 0.000352 | 0.000239 | >200 |
| Comp. | | | | | | | | | | | | | | | |
| Ex. No. | | | | | | | | | | | | | | | |
| II-1 | 1 | | | | | | 2 | | 75 | 12.6 | 1,426,000 | 724,000 | 0.000642 | 0.000326 | >200 |
| II-2 | 1 | | | | | | | | 50 | 13.5 | 1,196,000 | — | 0.008515 | 0.000925 | >200 |
| II-3 | | | | | | | 2 | | 45 | 8.9 | 6,875,000 | 1,325,000 | 0.002016 | 0.000951 | 43 |
| II-4 | | | | | | | | 2 | 61 | 7.5 | 6,875,000 | 127,000 | 0.000351 | 0.000218 | 20 |

| | | | | | | | The Number of Nano | | |
|---|---|---|---|---|---|---|---|---|---|
| | | | Hydrogen | | Sulfuric | | Scratches According to | | |
| | | Abrasive | Peroxide | HEDP | Acid | | the Standard Test | | |
| | Polishing | (% by | (% by | (% by | (% by | | Relative | | |
| | Composition | weight) | weight) | weight) | weight) | pH | Value | (#/side) | (#/cm²) |
| Ex. No. | | | | | | | | | |
| II-1 | a′ | 7.0 | 0.6 | 0.13 | 0.4 | 1.4 | 0.68 | 82 | 1.2 |
| II-2 | b′ | 7.0 | 0.6 | 0.13 | 0.4 | 1.4 | 0.52 | 62 | 0.94 |
| II-3 | c′ | 7.0 | 0.6 | 0.13 | 0.4 | 1.4 | 0.37 | 44 | 0.67 |
| II-4 | d′ | 7.0 | 0.6 | 0.13 | 0.4 | 1.4 | 0.36 | 43 | 0.65 |
| II-5 | e′ | 7.0 | 0.6 | 0.13 | 0.4 | 1.4 | 0.64 | 77 | 1.2 |
| Comp. | | | | | | | | | |
| Ex. No. | | | | | | | | | |
| II-1 | f′ | 7.0 | 0.6 | 0.13 | 0.4 | 1.4 | 1.00 | 120 | 1.8 |
| II-2 | g′ | 7.0 | 0.6 | 0.13 | 0.4 | 1.4 | 1.20 | 144 | 2.2 |
| II-3 | h′ | 7.0 | 0.6 | 0.13 | 0.4 | 1.4 | 1.23 | 148 | 2.2 |
| II-4 | i′ | 7.0 | 0.6 | 0.13 | 0.4 | 1.4 | 0.47 | 56 | 0.85 |

It can be seen from the results in Table 3 that the polishing compositions a′ to e′ obtained in Examples II-1 to II-5 can remarkably reduce nano scratches productively as compared to the polishing compositions f′ to i′ obtained in Comparative Examples II-1 to II-4.

### Example III

Polishing was evaluated with a Ni-P plated aluminum alloy substrate having a thickness of 1.27 mm and a diameter of 95 mm as a substrate to be polished, wherein the substrate was previously roughly polished with a polishing liquid containing an alumina abrasive to adjust its surface roughness (Ra) to 1 nm and waviness (Wa) to 4.8 nm.

### Preparation of Polishing Composition 1

Seven percent by weight colloidal silica particles (commercially available from DuPont, average particle size of primary particles: 22 nm, a product having a concentration of silica particles: 40% by weight) as an abrasive, 0.6% by weight of a 35% by weight hydrogen peroxide (commercially available from Asahi Denka Co., Ltd.) were added to ion-exchanged water, and an aqueous HEDP solution (60% by weight-product, commercially available from Solutia Japan Limited) was added thereto so as to adjust the pH to 1.5, to give a polishing composition. The polishing composition was filtered with a pleated type filter (commercially available from Advantec Toyo Kaisha, Ltd., “MCS-045-C10S”), to give a polishing composition 1. The polishing particles in the polishing composition 1 were determined. As a result, the number of silica particles having sizes of 0.56 μm or more and less than 1 μm (the number of coarse polishing particles in the table) was 53,000 per 1 cm³, and the polishing particles having sizes of 1 μm or more was 0.000042% by weight to the entire polishing particles.

Also, the polishing composition 1 was subjected to Nano Scratch Standard Test. As a result, the number of nano scratches was 0.08/cm².

### Preparation of Polishing Composition 2

Seven percent by weight colloidal silica particles (commercially available from DuPont, average particle size of primary particles: 10 nm, a product having a concentration of silica particles: 40% by weight) as an abrasive, and 0.6% by weight of a 35% by weight hydrogen peroxide (commercially available from Asahi Denka Co., Ltd.) were added to ion-exchanged water, and an aqueous HEDP solution (60% by weight-product, commercially available from Solutia Japan Limited) was added thereto so as to adjust the pH to 1.5, to give a polishing composition. The polishing composition was filtered with a pleated type filter (commercially available from Advantec Toyo Kaisha, Ltd., “MCP-JX-C10S”), to give a polishing composition 2. The polishing particles in the polishing composition 2 were determined. As a result, the number of silica particles having sizes of 0.56 μm or more and less than 1 μm was 137,400 per 1 cm³, and the polishing particles having sizes of 1 μm or more was 0.000086% by weight to the entire polishing particles.

Also, the polishing composition 2 was subjected to Nano Scratch Standard Test. As a result, the number of nano scratches was 0.35/cm².

### Preparation of Polishing Composition 3

The same procedures as those in the preparation of the polishing composition 1 were carried out except that a pleated type filter was not used to give a polishing composition 3. The polishing particles in the polishing composition 3 were determined. As a result, the number of silica particles having sizes of 0.56 μm or more and less than 1 μm was 520,500 per 1 cm³, and the polishing particles having sizes of 1 μm or more was 0.000242% by weight to the entire polishing particles.

Also, the polishing composition 3 was subjected to Nano Scratch Standard Test. As a result, the number of nano scratches was 5.5/cm².

### Preparation of Polishing Composition 4

The same procedures as those in the preparation of the polishing composition 1 were carried out except that the polishing composition was filtered with a pleated type filter (commercially available from Advantec Toyo Kaisha, Ltd., “MCP-FX-C10S”) to give a polishing composition 4. The polishing particles in the polishing composition 4 were determined. As a result, the number of silica particles having sizes of 0.56 μm or more and less than 1 μm was 181,200 per 1 cm³, and the polishing particles having sizes of 1 μm or more was 0.000166% by weight to the entire polishing particles.

Also, the polishing composition 4 was subjected to Nano Scratch Standard Test. As a result, the number of nano scratches was 1.3/cm².

### Preparation of Polishing Composition 5

The same procedures as those in the preparation of the polishing composition 1 were carried out except that the pH was adjusted to 9.5, and that the abrasive concentration in the polishing composition was 2% by weight to give a polishing composition. The resulting polishing composition was further filtered with a pleated type filter (commercially available from Advantec Toyo Kaisha, Ltd., “MCP-JX-C10S”), to give a polishing composition 5. The polishing particles in the polishing composition 5 were determined. As a result, the number of silica particles having sizes of 0.56 μm or more and less than 1 μm was 101,000 per 1 cm³, and the polishing particles having sizes of 1 μm or more was 0.000042% by weight to the entire polishing particles.

### Preparation of Polishing Composition 6

The same procedures as those in the preparation of the polishing composition 1 were carried out except that the abrasive concentration in the polishing composition was 3.5% by weight to give a polishing composition. This polishing composition was further filtered with a pleated type filter (commercially available from Advantec Toyo Kaisha, Ltd., “MCS-045-C10S”), to give a polishing composition 6. The polishing particles in the polishing composition 6 were determined. As a result, the number of silica particles having sizes of 0.56 μm or more and less than 1 μm was 26,000 per 1 cm³, and the polishing particles having sizes of 1 μm or more was 0.000062% by weight to the entire polishing particles.

### Preparation of Polishing Composition 7

The same procedures as those in the preparation of the polishing composition 2 were carried out except that the abrasive concentration in the polishing composition was 2% by weight to give a polishing composition. This polishing composition was further filtered with a pleated type filter (commercially available from Advantec Toyo Kaisha, Ltd., “MCS-045-C10S”), to give a polishing composition 7. The polishing particles in the polishing composition 7 were determined. As a result, the number of silica particles having sizes of 0.56 μm or more and less than 1 μm was 85,000 per 1 cm³, and the polishing particles having sizes of 1 μm or more was 0.000065% by weight to the entire polishing particles.

### Examples III-1 to III-11 and Comparative Examples III-1 to III-4

A substrate was polished with each of the polishing compositions 1 to 7 under the polishing conditions as shown below and in Table 4.

### III-1. Polishing Conditions

Polishing testing machine: commercially available from SpeedFam Co., Ltd., Double-sided 9B Polishing Machine
Polishing pad: commercially available from FUJI SPINNING Co., Ltd., polishing pad made of urethane (thickness: 0.9 mm, average pore size: 30 μm)
Rotational speed of platen: 32.5 r/min
Feeding rate of polishing composition per 1 cm² of area to be polished of a substrate: 0.03 to 0.15 cm³/min
Polishing time period: 4 minutes
Platen pressure (polishing pressure): 2 to 20 kPa
Number of substrates introduced: 10

The nano scratches of each of the substrates obtained in Examples III-1 to III-11 and Comparative Examples III-1 to III-4 were determined in the same manner as in Example I except that the conditions of the feeding rate (flow rate) of the polishing composition and platen pressure were changed. The results obtained are shown in Table 4.

TABLE 4

| | | Number of | | | | | |
|---|---|---|---|---|---|---|---|
| | Polishing | Coarse Polishing | | Platen | Concentration | pH of | Nano |
| | Composition | Particles | Flow Rate | Pressure | of Abrasive | Polishing | Scratches |
| | No. | (#/cm³)*) | (cm³/min.) | (kPa) | (% by weight) | Waste Liquid | (#/side) |
| Ex. No. | | | | | | | |
| III-1 | 1 | 53,000 | 0.15 | 3 | 7 | 1.6 | 26 |
| III-2 | 1 | 53,000 | 0.15 | 8 | 7 | 1.7 | 5 |
| III-3 | 1 | 53,000 | 0.15 | 15 | 7 | 1.8 | 18 |
| III-4 | 1 | 53,000 | 0.06 | 8 | 7 | 1.9 | 25 |
| III-5 | 6 | 26,000 | 0.15 | 8 | 3.5 | 1.6 | 25 |
| III-6 | 2 | 137,400 | 0.15 | 8 | 7 | 1.7 | 23 |
| III-7 | 2 | 137,400 | 0.09 | 8 | 7 | 1.7 | 25 |
| III-8 | 4 | 181,200 | 0.15 | 8 | 7 | 1.6 | 89 |
| III-9 | 7 | 85,000 | 0.15 | 8 | 2 | 1.6 | 65 |
| III-10 | 1 | 53,000 | 0.15 | 2 | 7 | 1.6 | 78 |
| III-11 | 1 | 53,000 | 0.15 | 20 | 7 | 1.9 | 65 |
| Comp. | | | | | | | |
| Ex. No. | | | | | | | |
| III-1 | 3 | 520,500 | 0.15 | 8 | 7 | 1.7 | 361 |
| III-2 | 3 | 520,500 | 0.15 | 2 | 7 | 1.6 | 226 |
| III-3 | 4 | 181,200 | 0.03 | 8 | 7 | 1.7 | 266 |
| III-4 | 5 | 101,000 | 0.15 | 8 | 2 | 10.2 | 3655 |

*)The number of polishing particles having sizes of 0.56 μm or more and less than 1 μm per 1 cm³ of polishing composition.

It can be seen from the results in Table 4 that nano scratches are significantly reduced in the substrates obtained in Examples III-1 to III-11 as compared to those of Comparative Examples III-1 to III-4.

The polishing composition of the present invention is suitable for polishing substrates for precision parts including, for example, recording disk substrates, such as magnetic disks, optical disks, and opto-magnetic disks, photomask substrates, optical lenses, optical mirrors, optical prisms and semiconductor substrates, and the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process for producing a polishing composition comprising an abrasive and water, wherein the polishing composition has a pH of from 0.1 to 7, and satisfies the following conditions:
(1) that the number of polishing particles having sizes of 0.56 μm or more and less than 1 μm is 500,000 or less per 1 cm³ of the polishing composition; and
(2) that the ratio of polishing particles having sizes of 1 μM or more is 0.001% by weight or less to the entire polishing particles in the polishing composition;
said process comprising the following purification steps of:
(I) filtering a pre-purification polishing composition with a depth-type filter, to give an intermediate filtrate; and
(II) filtering the intermediate filtrate with a pleated type filter, to give the polishing composition,
wherein the fluctuation range of the pressure at an inlet of the depth-type filter in the step (I) is 50 kPa or less.

2. The process according to claim 1, wherein the number of polishing particles having sizes of 0.56 μm or more and less than 1 μm is 1,000,000 or less per 1 cm³ of the intermediate filtrate obtained after the step (I).

3. The process according to claim 1, wherein the number of polishing particles having sizes of 0.56 μm or more and less than 1 μm is 1,000,000 or less per 1 cm³ of the intermediate filtrate to be supplied for the step (II).

4. The process according to claim 1, wherein the polishing composition further satisfies the following condition:
(3) that the ratio of polishing particles having sizes of 3 μm or more is 0.0008% by weight or less to the entire polishing particles in the polishing composition.

5. The process according to claim 1, wherein the abrasive has an average particle size of primary particles of from 1 to 50 nm.

6. The process according to claim 1, wherein the abrasive is contained in the polishing composition in an amount of from 0.5 to 20% by weight.

7. The process according to claim 1, wherein the abrasive is colloidal silica.

8. The process according to claim 1, wherein the polishing composition is used for a magnetic disk substrate.

9. The process according to claim 1, wherein the number of nano scratches of a polished substrate is 1.5 or less per 1 cm² according to a standard test.

10. A method for manufacturing a substrate, comprising the step of polishing a substrate with a polishing machine using the polishing composition produced by the process of claim 1.

11. The method according to claim 10, wherein the substrate is a magnetic disk substrate.

12. The method according to claim 11, wherein the magnetic disk substrate is a Ni-P plated aluminum alloy substrate.

13. The method according to claim 10, wherein the method comprising the step of polishing a substrate to be polished while feeding the polishing composition to the polishing machine comprising a platen at a flow rate of 0.06 cm³/minute or more per 1 cm² of an area to be polished of the substrate.

14. The method according to claim 10, wherein the platen pressure of the polishing machine is from 3 to 50 kPa.

15. The method according to claim 10, wherein the method comprises plural polishing steps, wherein the polishing composition is used for a finish polishing.

16. The method according to claim 10, wherein a difference between a pH of the polishing composition before polishing and a pH of a waste liquid after polishing is 2 or less.
